(19) United States
(12) Patent Application Publication
(10) Pub. No.: US 2026/0346166 A1
(43) Pub. Date: Nov. 5, 2026

(54) A HOPPER FOR TRANSPORTING SLUDGE

(71) Applicant: Elajo Technology Solutions AB, Oskarshamn (SE)

(72) Inventor: Robert RÅHLIN, Växjö (SE)

(73) Assignee: Elajo Technology Solutions AB, Oskarshamn (SE)

(21) Appl. No.: 19/120,579

(22) PCT Filed: Oct. 16, 2023
(86) PCT No.: PCT/EP2023/078651

§ 371 Date: Apr. 11, 2025

(30) Foreign Application Priority Data
Oct. 20, 2022 (EP) 22202807.8

(51) Int. Cl. B01D 21/24; B01D 21/30

(52) U.S. Cl. CPC B01D 21/2472; B01D 21/30

(57) ABSTRACT

A hopper configured to receive sludge from a solid-liquid separator and to transport the sludge by means of gravity wherein said hopper comprises at least one wall extending along the direction of transportation of the sludge and wherein said hopper further comprises at least one nozzle configured to spray a liquid onto the at least one wall of the hopper. Further related is a solid-liquid separator arrangement and a method for transporting sludge.

### TECHNICAL FIELD

The present invention relates to a hopper, and especially a hopper for transporting sludge.

### BACKGROUND

In e.g. oat drink production solid-liquid separation, for instance through centrifugation, is a common production step from which a sludge and a liquid are produced. There is an increased need to decrease waste from food production due to environmental and food security reasons. In order to process the sludge, a hopper may be arranged in connection with a solid-liquid separator to transport the sludge to e.g. a pump. However, with liquid removed, the sludge may have a texture that makes it complicated to transport. Consequently, there is a need for a solution which enhances the utilization of the produced sludge.

### SUMMARY

It is an object of the present invention to provide an improved solution that alleviates the mentioned drawbacks with present devices. Furthermore, it is an object to provide hopper that facilitates transport of sludge.

The invention is defined by the appended independent claims, with embodiments being set forth in the appended dependent claims, in the following description and in the drawings.

According to one aspect of the present invention there is provided a hopper configured to receive sludge from a solid-liquid separator and to transport the sludge by means of gravity. The hopper comprises at least one wall extending along the direction of transportation of the sludge. Moreover, the hopper comprises at least one nozzle configured to spray a liquid onto the at least one wall of the hopper. The at least one nozzle is a flat spray nozzle, a cone nozzle or a hollow cone nozzle.

The hopper may enable transportation of sludge from the solid-liquid separator. Said transportation of sludge may be enabled without decreasing the dry water content of the sludge with more than a few percent. To keep the dry water content low may be important for the utilization of the sludge. Instead of increasing the amount of water in sludge, which may reduce the risk of sludge attaching to the wall of the hopper, but which is not desired for the utilization of the sludge, a small amount of liquid is sprayed on the wall to prevent the sludge from attaching to the wall. The hopper may be attached to the solid-liquid separator. Spraying water through the at least one nozzle towards a wall of the hopper may remove attachment of sludge to said wall of the hopper by decreasing friction between the sludge and said wall so as the sludge can slide along the wall.

A flat spray nozzle, cone nozzle or hollow cone nozzle may contribute to a large spread of the ejected liquid so as the friction may be decreased between the sludge and a large part of the wall onto which the nozzle sprays while minimizing the amount of sprayed liquid in order to minimize the increment of the dry content of the sludge. A goal may be to achieve as effective lowering of friction on the at least one wall as possible with as low amount of liquid as possible since the level of dry matter content of the sludge may not be desired to decrease. The nozzle may be formed to achieve a pressure drop at the nozzle, such that the liquid is sprayed on the wall.

In a preferred embodiment a flat spray nozzle may be used, which may achieve a spraying effect with minimal amount of liquid. By using a flat spray nozzle, the area of the at least one wall that may be sprayed may be limited, providing line-shaped spraying area on the at least one wall. The flat spray nozzle may be arranged such that the line-shaped spraying area extends in a direction substantially perpendicular to the transportation direction of the sludge.

In one embodiment the hopper may comprise several nozzles, such as two, three, four or more nozzles. The nozzles may be arranged to spray onto different walls of the hopper. Alternatively, more than one nozzle may spray liquid onto each or some of the at least one wall of the hopper.

The inclusion of several nozzles may be more effective in transporting the sludge since the friction between the sludge and at more portions of the walls of the hopper may be decreased. Further, the amount of liquid being sprayed on the area of the at least one wall may be further controlled.

In one embodiment the hopper may comprise a curved pipe which protrudes from the at least one wall and is curved towards the at least one wall, wherein the nozzle is attached to said curved pipe.

A curved pipe may be suitable for providing the nozzle with the liquid in an appropriate direction in relation to the wall so as friction can be decreased between the wall and the sludge. A curved pipe may also be suitable for not impacting the liquid flow which an edgy pipe may do. Further, with such curved pipe, it may be avoided that the pipe and nozzle interfere with the sludge being transported through the hopper.

In one embodiment the at least one nozzle may be directed towards the at least one wall with an angle between 80 and 120 degrees, preferably between 90 and 110 degrees, or more preferably between 95 and 105 degrees.

The direction of the nozzle may provide a desired angle between the ejected water and the wall, such as an angle between 95 and 105 degrees, which may further contribute to a desired spread of the ejected liquid so as to decrease friction between the wall and the sludge and minimizing the amount of needed sprayed liquid. The droplets of the liquid should preferably not bounce on the wall, but stay on the wall and form a thin film of liquid that prevents the sludge to stick on the wall. With a desired angle of the nozzle, and thereby the liquid reaching the wall, the effect of the liquid on the wall may be improved with a low amount of needed liquid.

In one embodiment the hopper may be configured to receive sludge that has between 30% and 45% dry matter content.

A dry matter content between 30 and 45% may be suitable for the sludge to be effectively utilized e.g. for food production.

In one embodiment the at least one nozzle may be configured to supply liquid that decrease the dry matter content of the received sludge with less than 2%.

Due to the stated dry matter content range, which the sludge may have when leaving the solid-liquid separator, it may be desirable to avoid a too large increase of said dry matter content. The level of dry matter content may not decrease such that possibility to utilize the sludge is too much negatively affected.

In one embodiment the liquid may be water.

Water may be a suitable liquid since it is appropriate to use in the food industry and it decreases friction between the sludge and the at least one wall.

In one embodiment the liquid may comprise a lubricant or a solvent.

The liquid being a mix between water and a lubricant may enable to further decrease the amount of sprayed liquid and still achieving sufficient friction between the wall and the sludge. The dry content of the sludge may thereby be affected even less than if pure water is used.

In one embodiment the at least one nozzle may be configured to provide a liquid pressure of between 3 and 4 bar.

A liquid pressure between 3 and 4 bar may be suitable to spray an appropriate amount of liquid in order to achieve sufficient friction and not affect the dry content of the sludge to a too large degree.

In one embodiment the hopper may be shaped as a funnel which is narrowing in the direction of transportation of the sludge.

A funnel shaped hopper may be suitable to connect the solid-liquid separator with a pump whereas the sludge is moved through the hopper by means of gravity.

In one embodiment the hopper may comprise a weight cell which is configured to monitor occurrence of excess amount of sludge attaching to the at least one wall.

The weight cell may continuously or repeatedly measure the weight of the hopper, whereas the weight of the hopper may indicate whether an accumulation of excess sludge is occurring.

In one embodiment the hopper may comprise a controlling means configured to control liquid flow provided to the at least one nozzle based on a signal from said weight cell.

The controlling means may by adjusting the flow provided to the at least one nozzle counteract excess sludge being attached to the hopper, which may cause clog and bridge building. Thereby the controlling means may increase the liquid flow in response to occurring excess attachment and so decrease the friction further between the sludge and the hopper. In such manner the attachment of sludge may be decreased, and bridge and clog building may be prevented.

In one embodiment the nozzle may be arranged less than 10 cm from the at least one wall.

In one embodiment the hopper may be configured for transportation of a food residual sludge product.

In one embodiment the hopper may be configured to be arranged to a pump and to transport the sludge to said pump.

According to a second aspect of the invention there is provided a solid-liquid separator arrangement. The solid-liquid separator arrangement comprises a solid liquid separator and the hopper according to any one of the embodiments of the above described first aspect of the invention. The arrangement further comprises a pump. The hopper is configured to transport sludge received from the solid-liquid separator to the pump.

In one embodiment the solid liquid separator arrangement may be configured for oat drink production.

The arrangement may enable production of oat drink and utilization of sludge that may be a residual product of the oat drink production. The sludge may effectively be transported to the pump and pumped into an outflow pipe with said arrangement.

In one embodiment there may be arranged at least one weight cell in connection to the hopper and/or the pump and there may be arranged a pressure sensor in an outflow pipe of the pump. Measurements of said at least one weight cell and/or the pressure sensor may be used to control the liquid flow provided to the at least one nozzle.

Thereby the outflow of liquid through the at least one nozzle may be held sufficiently high to prevent accumulation of sludge in the hopper and sufficiently low to not decrease the dry water content of the sludge to an undesired level.

In one embodiment the solid liquid separator may be a centrifuge. A centrifuge may be suitable for producing oat drink and a sludge which may be utilized with the present invention.

According to a third aspect of the present invention there is provided a method for transporting sludge from a solid-liquid separator. The method comprises the steps of allowing the sludge to move through a hopper by means of gravity, measuring a load onto the hopper with a weight cell, spraying a liquid onto at least one wall of the hopper through at least one nozzle and adjusting the liquid flow provided to the at least one nozzle based on measured values of the weight cell.

The method may provide the same benefits as the hopper and/or the solid-liquid arrangements as described above. With the provided method improved utilization of the sludge may be enabled. Further, clogging and bridge building of the sludge in the hopper may be prevented.

In one embodiment the method may comprise a preliminary step of solid-liquid production through centrifugation in which oat drink and a sludge are produced from an oat mix solution.

In one embodiment the method may comprise a step of pumping sludge with a pump which receives the sludge from the hopper.

The hopper may be a hopper according to any one of the embodiments described above, comprising a flat spray nozzle, a cone nozzle, or a hollow cone nozzle.

### BRIEF DESCRIPTION OF THE DRAWINGS

The invention will in the following be described in more detail with reference to the enclosed drawings, wherein:

FIG. 1 shows schematic side view of an arrangement according to an embodiment of the invention;

FIG. 2 shows a side view of a hopper according to an embodiment of the invention;

FIG. 3 shows a side view of a hopper according to an embodiment of the invention; and

FIG. 4 shows a flow chart of a method according to an embodiment of the invention.

### DETAILED DESCRIPTION

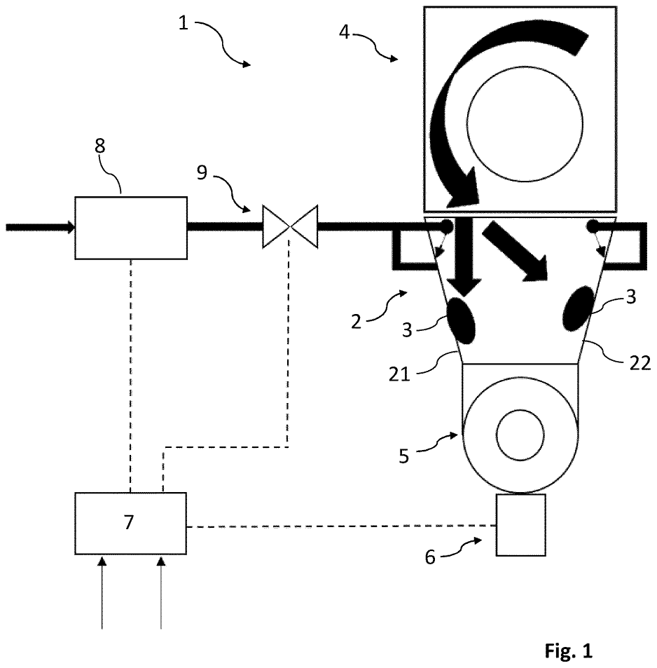

The present invention will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements. In FIG. 1 a solid-liquid separator arrangement 1 is illustrated. The solid liquid arrangement comprises a centrifuge 4. The centrifuge 4 is configured to be provided with a mixture which includes e.g. oat. In some embodiments another mixture is centrifugated. Through the centrifugation an oat drink is produced which is output through an outflow of the centrifuge 4. In the centrifuge 4, sludge 3 is also produced as a residual product. The sludge 3 is received by a hopper 2, which is configured, by its shape and size, to let the sludge move through said hopper 2 by means of gravity.

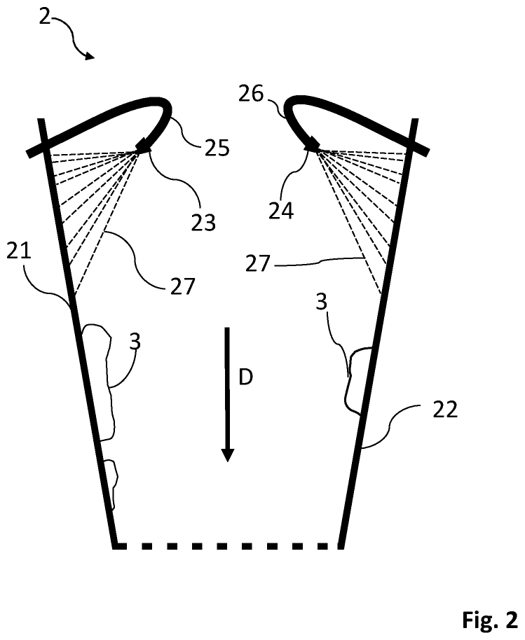

The hopper 2 is seen in more detail in FIG. 2. The sludge 3 moves through the hopper 2 by means of the gravitational force, which is directed downwards in the direction D. Due to the consistence of the sludge, which in some embodiments is a sticky paste, friction between the sludge and walls of the hopper 2 emerges and the sludge tends to stick to the walls. The hopper 2 is in some embodiments shaped as a funnel, which is to be interpreted as that the cross section of the hopper is narrowing towards the bottom of the hopper. The hopper 2 comprises nozzles 23, 24 which are configured to spray liquid onto one wall 21, 22 each. In the illustrated embodiment the hopper 2 comprises two nozzles.

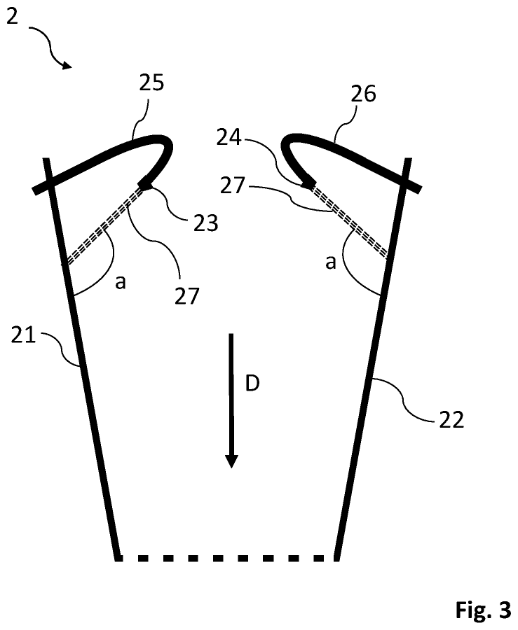

Each nozzle 23, 24 is provided with water through a curved pipe 25, 26 which protrudes from a wall 21, 22 and is configured to spray water 27 with an angle a of about 100 degrees from the walls 23, 24 respectively. Said angle a is seen in the vertical cross-sectional image of the hopper 2 in FIG. 3. The angle a may be defined as an angle between the wall 21, 22 and the direction of the nozzle 23, 24. By spraying water 27 with an angle a, a large area of respective walls of the hopper are reached by ejected droplets from the nozzle. In other embodiments the nozzle is configured to spray water towards a wall 21 of the hopper 2 with another angle.

In the embodiment in FIG. 3, the nozzles 23, 24 are flat spray nozzles. The flat spray nozzles eject water 27 mainly in the form of a horizontal line on the wall 21, 22 of the hopper 2. The horizontal line extends in a direction substantially perpendicular to the direction D of transportation of the sludge 3. The water 27 sprayed with the flat spray nozzles then run down along the walls 21, 22 of the hopper 2. By using flat spray nozzles, less amount of water 27 can cover a large area of the walls 21, 22.

In some embodiments there are several nozzles spraying towards one wall 21.

Below the hopper 2, arranged to the hopper 2 or to a pump 5, there is a weight cell 6 which is configured to measure the load onto the hopper from the sludge 3, as illustrated in FIG. 1.

The solid liquid separator arrangement 1 also comprises a pump 5 which is connected to the hopper. The pump 5 is configured to receive sludge 3 from the hopper 2 and pump it through an outlet channel. In the outflow channel of the pump 5 there is, in some embodiments, arranged a pressure sensor which is configured to measure the pressure of the sludge 3 in the outlet channel.

Further, the arrangement 1 comprises a controlling means 7, configured to receive measurements from the weight cell 6 and/or the pressure sensor. There is arranged a control valve 9 in an inflow channel to the at least one nozzle 23, 24. The controlling means 7 is configured to control the control valve 9 based on input from the weight cell 6 and/or the pressure sensor.

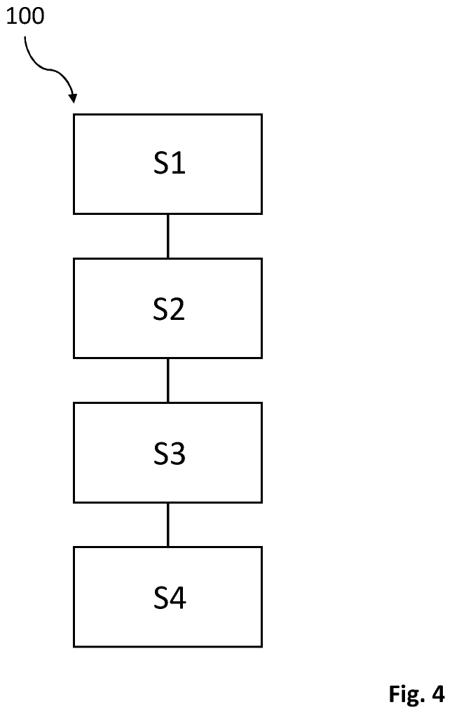

In FIG. 4 there is disclosed a flow chart of steps of a method 100 for transporting sludge 3 from a solid-liquid separator. Sludge 3 is formed by solid-liquid separation, e.g. centrifugation of a mixture which comprises oat. From the solid-liquid separator 4, a liquid is produced which is lead through an outlet of the separator 4. The sludge 3 that is formed is let out through another outlet of the solid-liquid separator. The method 100 comprises a step of allowing S1 sludge 3 to move through a hopper 2 by means of gravity. Whereas the gravity implies a downward force onto the sludge, friction between the sludge and one or several walls 21, 22 of the hopper counteracts the transportation of the sludge 3. The method 100 comprises a second step of spraying S2 a water film onto at least one wall 21 of the hopper 2 through at least one nozzle 23, 24. The water film is formed by droplets which are ejected by the nozzle 23, 24. Some of the droplets are ejected with an angle of about 100 degrees from the wall 21 of the hopper. Several nozzles may spray water onto one wall 21 each or several nozzles per wall.

By spraying droplets towards at least one wall 21 of the hopper the friction is decreased between the sludge 3 and the walls so as the transportation of sludge through the hopper 2 is facilitated. The sludge 3 is transported to a pump 5 below the hopper 2. The pump 5 pumps the sludge 3 through a pump outlet. The method comprises a third step of measuring S3 weight onto the hopper 2 with a weight cell 6. The weight cell 6 measures the weight onto the hopper continuously or repeatedly. The weight cell 6 is located below the hopper and in some embodiments even below the pump 5. Moreover, in the pump outlet, there is arranged a pressure sensor which continuously or repeatedly measures the pressure in the pump outlet. The measurement information is sent from the weight cell 6 and the pressure sensor to a controlling means 7.

The method comprises a fourth step of adjusting S4 the liquid flow provided to the at least one nozzle 23, 24 based on measured values from the weight cell 6. At an inflow to the at least one nozzle there is arranged a control valve 9. The controlling means 7 controls the liquid pressure provided to the at least one nozzle 23, 24 through the control valve 9. If the weight onto the hopper 2 is high there is an indication that more liquid should be ejected by the at least one nozzle and therefore the control valve 9 should provide a higher liquid flow to the at least one nozzle 23, 24. The controlling means 7 may further receive input from a flow meter 8. The controller means 7 does however also base the liquid flow that it controls the control valve 9 to give, by the pressure sensor in the pump outflow. If said pressure sensor registers a low pressure, it is an indication that the dry matter content of the sludge 3 is low, which is counteracted by decreasing the liquid flow provided to the at least one nozzle 23, 24. The controlling means 7 controls the control valve 9 based on both the liquid flow measured in the pump outflow and the weight measured by said weight cell 6.

In the drawings and specification, there have been disclosed preferred embodiments and examples of the invention and, although specific terms are employed, they are used in a generic and descriptive sense only and not for the purpose of limitation, the scope of the invention being set forth in the following claims.

1. A hopper configured to receive sludge from a solid-liquid separator and to transport the sludge by means of gravity; said hopper comprising at least one wall extending along the direction of transportation of the sludge; wherein said hopper comprises at least one nozzle configured to spray a liquid onto the at least one wall of the hopper, the at least one nozzle being a flat spray nozzle, a cone nozzle or a hollow cone nozzle.

2. The hopper according to claim 1, further comprising a curved pipe which protrudes from the at least one wall and is curved towards the at least one wall, wherein the nozzle is attached to said curved pipe.

3. The hopper according to claim 1, wherein the nozzle is a flat spray nozzle configured to spray the liquid along a direction substantially perpendicular to the direction of transportation.

4. The hopper according to claim 1, wherein the at least one nozzle is directed towards the at least one wall with angle (a) between 80 and 120 degrees, preferably between 90 and 110 degrees.

5. The hopper according to claim 1, wherein hopper is configured to receive sludge that has between 30% and 45% dry matter content.

6. The hopper according to claim 1, wherein the liquid is water.

7. The hopper according to claim 1, wherein the liquid comprises a lubricant or a solvent.

8. The hopper according to claim 1, wherein the at least one nozzle is configured to be provided a liquid pressure of between 3 and 4 bar.

9. The hopper according to claim 1, wherein the nozzle is arranged less than 10 cm from the at least one wall.

10. The hopper according to claim 1, wherein the sludge is a food residual product.

11. The hopper according to claim 1, wherein the hopper is configured to be arranged to a pump such that the sludge is transported through the hopper to said pump.

12. A solid-liquid separator arrangement comprising a hopper according to claim 1, wherein the solid-liquid separator arrangement further comprises a solid-liquid separator and a pump, wherein the hopper is configured to transport sludge received from the solid-liquid separator to the pump.

13. The solid-liquid separator arrangement according to claim 12, further comprising at least one weight cell arranged in connection to the hopper and/or the pump and wherein a pressure sensor is arranged in an outflow pipe of the pump and wherein measurements of said at least one weight cell and/or the pressure sensor are used to control the liquid flow provided to the at least one nozzle

14. A method for transporting sludge from a solid-liquid separator, said method comprising the steps of allowing the sludge to move through a hopper by means of gravity; measuring a load onto the hopper with a weight cell; spraying a liquid onto at least one wall of the hopper through at least one nozzle adjusting the liquid flow provided to the at least one nozzle based on measured values from the weight cell.

15. The method according to claim 14, wherein the hopper comprises at least one wall extending along the direction of transportation of the sludge; wherein said hopper comprises at least one nozzle configured to spray a liquid onto the at least one wall of the hopper, the at least one nozzle comprising a flat spray nozzle, a cone nozzle or a hollow cone nozzle.
